(19) United States
(12) Patent Application Publication
(10) Pub. No.: US 2007/0002190 A1
(43) Pub. Date: Jan. 4, 2007

(54) Receiver

(75) Inventors: Minoru Maehata, Kobe-shi (JP); Kanako Nishida, Kobe-shi (JP); Momoko Fujiwara, Kobe-shi (JP); Naoshi Kakita, Kobe-shi (JP)

Correspondence Address: OLIFF & BERRIDGE, PLC, P.O. BOX 19928, ALEXANDRIA, VA, 22320, US

(73) Assignee: Fujitsu Ten Limited, Kobe-shi (JP)

(21) Appl. No.: 11/475,216

(22) Filed: Jun. 27, 2006

(30) Foreign Application Priority Data
Jun. 30, 2005 (JP) 2005-192819
May 17, 2006 (JP) 2006-138179

(51) Int. Cl. H04N 5/64

(52) U.S. Cl. 348/837

(57) ABSTRACT

The present invention relates to a receiving apparatus capable of achieving the efficiency of the antenna utilization among a plurality of tuners, and the apparatus of the present invention comprises a display section displaying individual images with respect to a plurality of viewing directions on the same screen, a plurality of tuners, a plurality of antennas connected to the plurality of tuners, an antenna switching section switching a connection state between the plurality of tuners and the plurality of tuners, a detection section detecting a difference or identification between a first broadcast program corresponding to an individual image with respect to one viewing direction and a second broadcast program corresponding to an individual image with respect to at least one viewing direction other than the one viewing direction, and a control section controlling the antenna switching means on the basis of a result of the detection by the detection section.

### BACKGROUND OF THE INVENTION

1) Field of the Invention

The present invention relates to a receiving apparatus, which is equipped with a display unit to enable a video picture (image) to be visible for each viewing direction, and more particularly to a receiving apparatus suitable for use in a vehicle.

2) Description of the Related Art

The recent vehicles, relatively large in number, have been equipped with a visual device having an image displaying function, such as navigation unit, television or DVD player. As such a conventional technique on a display unit for a vehicle, the patent document 1 discloses a display device designed such that two types of image displays are simultaneously achievable according to viewing directions by using one display unit properly on the basis of the fact that different display information are obtainable according to angle of visual line.

For such a display device (hereinafter referred to as a “multiview display device”) designed so as to use one display unit properly so that two types of image displays can simultaneously be made according to viewing directions, for handling the two types of image displays, consideration has been given to mounting two tuners for the reception of broadcasting electric-wave.

[Patent Document 1]

Japanese Patent Laid-Open No. 2003-137005

However, the aforesaid patent document 1 does not disclose any concrete technique for the utilization of an antenna among a plurality of tuners, but the efficient utilization of an antenna according to a viewing situation of a broadcast program using a plurality of tuners is a necessary technique for improving reception states of a plurality of broadcast programs to be displayed.

### SUMMARY OF THE INVENTION

The present invention has been developed in consideration of these problems, and it is therefore an object of the present invention to, in a receiving apparatus, promote the efficiency of utilization of an antenna among a plurality of tuners.

For this purpose, a receiving apparatus according to the present invention comprises a display section displaying individual images with respect to a plurality of viewing directions on the same screen, a plurality of tuners, a plurality of antennas connected to the plurality of tuners, an antenna switching section switching a connection state between the plurality of tuners and the plurality of antennas, a detection section detecting a difference or identification between a first broadcast program corresponding to an individual image with respect to one viewing direction and a second broadcast program corresponding to an individual image with respect to at least one viewing direction other than the one viewing direction, and a control section controlling the antenna switching section on the basis of a result of the detection by the detection section.

In addition, it is also possible that, when the first broadcast program and the second broadcast program are identical to each other, the control section controls the antenna switching section so that common diversity control is executed through the use of a first tuner receiving the first broadcast program and/or a second tuner receiving the second broadcast program and, when the first broadcast program and the second broadcast program are different from each other, the control section controls the antenna switching section so that diversity control is individually executed through the use of each of the first tuner and the second tuner.

In this case, it is also appropriate that the receiving apparatus further comprises a display control section controlling the switching between an individual display state in which a broadcast program received through the first tuner is set as the first broadcast program to be displayed on the display section while a broadcast program received through the second tuner is set as the second broadcast program to be displayed on the display section and a common display state in which a broadcast program received by the first tuner or the second tuner is set as the first broadcast program and the second broadcast program to be displayed on the display section.

Still additionally, preferably, the receiving apparatus further comprises a channel selection indicating section giving a channel selection indication (instruction) to at least one tuner and channel selection searching section giving an indication for a channel selection search to at least one of the plurality of tuners on the basis of said channel selection indication, and the display control section executes the switching control on the basis of a channel selection operation of at least the one tuner according to the indication for channel selection search from the channel selection searching section.

Yet additionally, it is also acceptable that, in a case in which a channel selection indication from the channel selection indicating section is detected when the first broadcast program and the second broadcast program are identical to each other, the channel selection searching section gives an indication for a channel selection search to one of the first tuner and the second tuner while the display control section executes the switching control at the time that the channel selection search by the one tuner reaches completion and a broadcast program received by the one tuner reaches a display-possible condition.

Moreover, it is also acceptable that, when the first broadcast program and the second broadcast program are identical to each other, the channel selection searching section gives an indication for a channel selection search to one of the first tuner and the second tuner.

Still moreover, it is also possible that the receiving apparatus further comprises a reception state detecting section detecting a reception state of the first tuner or the second tuner so that the channel selection searching section gives an indication for a channel selection search to the one tuner when the reception state detected by the reception state detecting section is equal to or higher than a predetermined threshold. Yet moreover, it is also possible that the receiving apparatus further comprises stopping state detecting section detecting a stopping state of a mobile object, on which the receiving apparatus is mounted, so that the channel selection searching section gives an indication for a channel selection search to the one tuner when the stopping state detecting section detects a stopping state of the mobile object.

In addition, it is also possible that the receiving apparatus further comprises a reception state detecting section detecting reception states of the first tuner and the second tuner so that the display control section executes the switching control to the common display state when, in the individual display state, the reception state detecting section detects that a reception state of one of the first tuner and the second tuner is equal to or lower than a predetermined threshold.

Still additionally, it is also appropriate that the receiving apparatus further comprises a plurality of sound outputting sections corresponding to individual images with respect to the plurality of viewing directions, a reception state detecting section detecting reception states of the plurality of tuners, and a sound control section making the reception state detecting section detect a tuner whose reception state is equal to or lower than a predetermined threshold and controlling the sound outputting section so as to mute a sound corresponding to a broadcast program received through this tuner.

Yet additionally, it is also appropriate that the receiving apparatus further comprises a sound outputting section outputting a plurality of sounds corresponding to individual images with respect to the plurality of viewing directions, an input source other than the plurality of tuners, a reception state detecting section detecting reception states of the plurality of tuners, and a sound control section making the reception state detecting section detect a tuner whose reception state is equal to or lower than a predetermined threshold and controlling the sound outputting section so as to switch a sound corresponding to a broadcast program, received by the tuner, to a sound from the input source.

Moreover, it is also appropriate that the receiving apparatus further comprises an antenna allocation specifying section specifying an allocation of the plurality of antennas to the plurality of tuners according to operating states of the tuners.

Still moreover, it is also appropriate that the receiving apparatus further comprises a movement state detecting section detecting a movement state of a mobile object, on which the receiving apparatus is mounted, and an antenna allocation specifying section specifying an allocation of the plurality of antennas to the plurality of tuners on the basis of a result of the detection by the movement state detecting section.

Furthermore, a receiving apparatus according to an invention related to the present invention comprises a multiview display unit including a first display section and a second display section whereby a video picture (image) from a first viewing direction and a video picture image from a second viewing direction are observable on the same display plane, a first tuner and a second tuner, a plurality of antennas for the first tuner and the second tuner, an antenna switching unit switching a connection state between the plurality of antennas and first and second tuners, a video picture (image) detecting section detecting a difference or identification between video pictures displayed on the first display section and the second display section, and a connection state change control unit controlling the antenna switching unit on the basis of a result of the detection by the video picture (image) detecting section to change the connection state between the plurality of antennas and the first and second tuners.

Still furthermore, preferably, the connection state change control unit controls the antenna switching unit so as to carry out spatial diversity control common to the first tuner and the second tuner while the video picture (image) detecting section detects that video pictures (images) displayed on the first display section and the second display section are identical to each other, and cancels the spatial diversity control common to the first tuner and the second tuner when the video picture (image) detecting section detects that the video pictures (images) displayed through the first tuner and the second tuner are not identical to each other and controls the antenna switching unit so as to individually carry out spatial diversity control for the first tuner and the second tuner.

Yet furthermore, it is also appropriate that the receiving apparatus further comprises a video picture control unit controlling a video picture (image) display state in the first display section and a video picture (image) display state in the second display section.

In addition, it is also appropriate that the receiving apparatus further comprises a channel selection indicating unit giving a channel selection indication to the first tuner and the second tuner and a channel selection searching unit carrying out a channel selection search in the first tuner and the second tuner on the basis of the channel selection indication from the channel selection indicating unit, and the video picture (image) control unit executes video picture (image) switching control on a video picture (image) from the first tuner and a video picture (image) from the second tuner on the basis of a channel selection searching operation by the channel selection searching unit.

In this case, preferably, when the channel selection indicating unit gives an indication for switching to a different program while identical programs are channel-selected by the first tuner and the second tuner, the channel selection searching unit carries out a channel selection search for the different program with respect to one of the first tuner and the second tuner, and the video picture (image) control unit carries out the video picture (image) switching when the channel selection search on the one tuner by the channel selection searching unit reaches completion and a video picture (image) display of the different program becomes possible through the one tuner.

Moreover, preferably, it is also appropriate that the receiving apparatus further comprises a channel selection in-search displaying section, during the channel selection search on the one tuner by the channel selection searching unit, displaying the fact of the channel selection search.

Still moreover, it is also appropriate that the channel selection searching unit carries out the channel selection search on the one tuner while the first tuner and the second tuner makes a channel selection of the same program.

In this case, the receiving apparatus further comprises a reception state detecting section detecting reception states of the first tuner and the second tuner, and the channel selection searching unit is made to carry out the channel selection search on one of the first tuner and the second tuner when the reception state detecting section detects a reception state equal to or higher than a threshold.

Furthermore, it is also acceptable that the receiving apparatus is mounted on a vehicle and comprises a stopping state detecting section detecting a stopping state of the vehicle so that the channel selection searching unit carries out a channel selection search on one of the first tuner and the second tuner when the stopping state detecting section detects the stopping state of the vehicle.

In this case, it is also appropriate that the receiving apparatus further comprises an antenna selecting unit for, when the stopping state detecting section detects the stopping state of the vehicle, selecting a display image antenna for an image to be displayed and selecting an antenna other than the display image antenna as an antenna for a channel selection search.

Still furthermore, it is also acceptable that the receiving apparatus is mounted on a vehicle and comprises a traveling state detecting section detecting a traveling state of the vehicle and, when the traveling state detecting section detects a traveling state of the vehicle, the video picture control unit carries out video picture switching so that a display observable in a viewing direction other than a driver's seat is made through a tuner whose reception state is equal to or higher than a threshold.

Yet furthermore, it is also acceptable that the receiving apparatus further comprises a reception state detecting section detecting reception states of the first tuner and the second tuner so that, when the reception state detecting section detects a reception state lower than a threshold in one of the first tuner and the second tuner, the video picture (image) control unit makes the switching to a video picture (image) from a tuner other than the tuner having the reception state lower than the threshold.

Moreover, it is also appropriate that, when the reception state detecting section detects a reception state lower than the threshold in one of the first tuner and the second tuner, the channel selection searching unit makes, in the tuner having the reception state lower than the threshold, a search on a program identical to a program from a tuner other than the tuner having a reception state lower than the threshold and, when the reception state of the tuner which has had the reception state lower than the threshold becomes equal to or higher than the threshold, the video picture (image) control unit makes the switching to a video picture (image) from the tuner having the reception state lower than the threshold in a display unit made to display a video picture (image) from the tuner which has had the reception state lower than the threshold.

Still moreover, it is also appropriate that the receiving apparatus further comprises a video picture (image) switching indicating unit giving a video picture (image) switching indication to one display section of the multiview display unit and, in response to the video picture (image) switching indication from the video picture (image) switching indicating unit, the video picture (image) control unit carries out a display, which is to be made on the other display section of the multiview display unit, on the one display unit.

Yet moreover, it is also appropriate that the receiving apparatus further comprises a multi-picture (image) display indicating unit carrying out an indication for display of video pictures (image) of a plurality of programs to one display section of the multiview display unit and, in response to the video picture (image) display indication from the multi-picture (image) display indicating unit, the video picture (image) control unit makes the video pictures (images) of the plurality of programs on the one display section.

In addition, it is also appropriate that the receiving apparatus further comprises a plurality of speakers for the first display section and the second display section in the multiview display unit and a sound control unit executing control on sounds to be outputted from the plurality of speakers.

In this case, it is also possible that the receiving apparatus further comprises a reception state detecting section detecting reception states of the first tuner and the second tuner and, when the reception state detecting section detects a reception state lower than a threshold in one of the first tuner and the second tuner, the video picture (image) control unit makes the switching to a video picture (image) from a tuner other than the tuner having the reception state lower than the threshold and, when the reception state detecting section detects a reception state lower than the threshold in one of the first tuner and the second tuner, the sound control unit makes the switching to a sound corresponding to the video picture (image) from the tuner other than the tuner having the reception state lower than the threshold.

Still additionally, it is also possible that the receiving apparatus further comprises a reception state detecting section detecting reception states of the first tuner and the second tuner and, when a state in which the reception state detecting section detects a reception state lower than the threshold in one of the first tuner and the second tuner continues for a predetermined period of time, the sound control unit mutes the sound corresponding to the video picture (image) from the tuner having the reception state lower than the threshold.

In this case, it is also appropriate that, when the reception state detecting section detects a state lower than a different threshold showing a higher degree of deterioration of reception state within a predetermined period of time after the detection of the reception state lower than the first-mentioned threshold in one of the first tuner and the second tuner, the sound control unit intercepts the sound corresponding to the video picture (image) from the tuner having the reception state lower than the different threshold.

Yet additionally, it is also appropriate that the receiving apparatus further comprises an input source unit, other than the first tuner and the second tuner, connected to the multiview display unit and a reception state detecting section detecting reception states of the first tuner and the second tuner and, when the reception state detecting section detects a reception state lower than a threshold in one of the first tuner and the second tuner, the sound control unit makes the switching to a sound from the input source unit.

Moreover, it is also possible that the sound control unit makes the switching to the sound from the tuner having the reception state lower than the threshold when the reception state of the tuner, which has had the reception state lower than the threshold, becomes equal to or higher than the threshold.

Still moreover, it is also possible that the receiving apparatus further comprises an antenna allocation specifying section specifying the allocation of the plurality of antennas to the first tuner and the second tuner according to operating states of the first tuner and the second tuner.

Thus, according to the present invention, the connection states between a plurality of antennas and a plurality of tuners can be switched in such a manner that the control section controls the antenna switching section on the basis of a result of the detection by the detecting section, thereby providing advantages of making the balance between high-quality image reception and multibroadcasting and of using a plurality of antennas for the reception in a plurality of tuners efficiently so as to carry out the multibroadcasting reception smoothly while achieving effective utilization.

### BRIEF DESCRIPTION OF THE DRAWINGS

FIG. 1 is a block diagram showing the entire configuration of a multiview display apparatus according to an embodiment of the present invention;

FIG. 2 is an illustrative view showing an example of a multiview display apparatus according to this embodiment being mounted in the interior of a vehicle room;

FIGS. 3 and 4 are illustrative views showing a multiview display unit according to this embodiment;

FIG. 5 to 15 are flow charts useful for explaining an operation of this embodiment;

FIG. 16 is an illustration of a vehicle room of a vehicle to which is applied a display apparatus according to a further embodiment of the present invention; and

FIG. 17 is a block diagram showing the entire configuration of a display apparatus according to the further embodiment of the present invention.

### DESCRIPTION OF THE PREFERRED EMBODIMENTS

Embodiments of the present invention will be described hereinbelow with reference to the drawings.

The above-mentioned and other technical objects, solving means and features of the present invention will become more readily apparent from the disclosures of the following embodiments.

[A] Description of an Embodiment

[A-1] About the Entire Configuration of a Multiview Display Apparatus 1

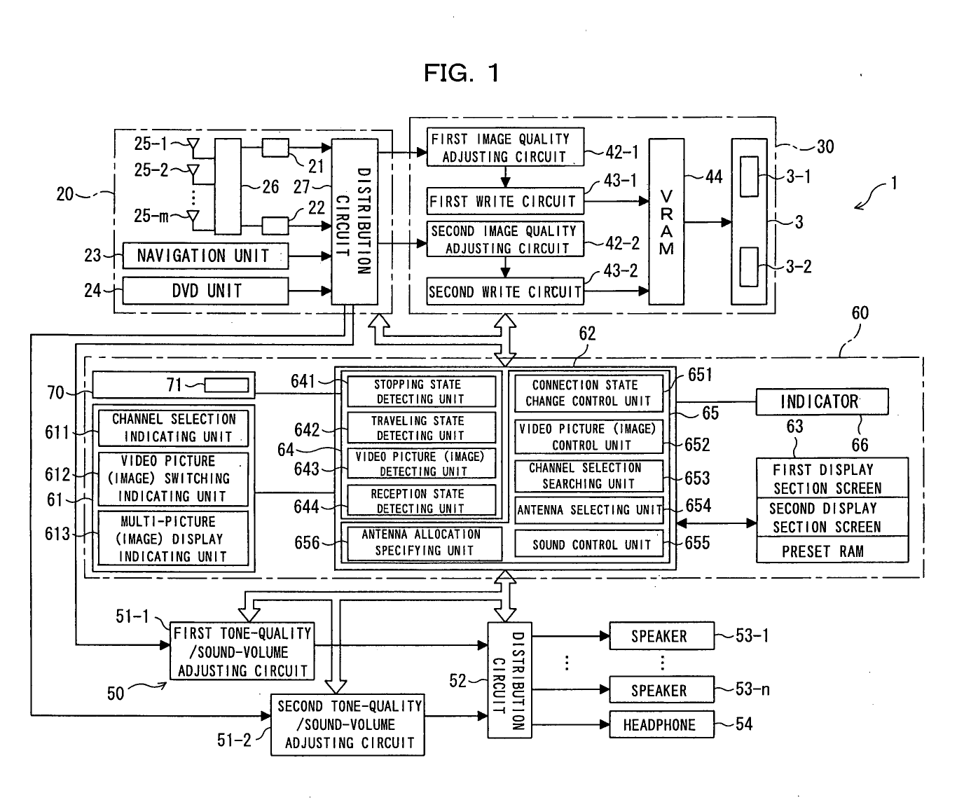

FIG. 1 is a block diagram showing the entire configuration of a multiview display apparatus 1 forming a receiving apparatus according to an embodiment of the present invention. As shown in FIG. 1, the multiview display apparatus 1 is mounted in a vehicle such as a car and is made to capture or receive source information (information serving as sources of video picture (image) and audio display) from first and second tuners 21 and 22 or source information from a navigation unit 23 and a DVD unit 24, which correspond to input sources, for displaying them through the use of a multiview display unit 3 and speakers 53-1 to 53-n, a headphone 54 or the like.

In addition, the multiview display unit (displaying section) 3 includes, on the same display plane, a first display section 3-1 whereby a driver's seat side individual video picture (image) is observable from a driver's seat side direction forming a first viewing direction and a second display section 3-2 whereby a front passenger seat (an assistant driver's seat) side individual video picture (image) is observable from a front passenger seat side direction forming a second viewing direction, and the above-mentioned source information different from each other can simultaneously be displayed on the first and second display sections 3-1 and 3-2.

Accordingly, the multiview display apparatus 1 shown in FIG. 1 is made up of a source information capturing unit 20 for capturing source information, a video picture (image) display processing unit 30 for conducting the display processing on video picture (image) information of the source information captured by the source information capturing unit 20, a sound output processing unit 50 for conducting the output processing on sound information of the source information captured by the source information capturing unit 20, and a detection control processing unit 60 for carrying out various types of detection processing and control processing.

In this configuration, the source information capturing unit 20 includes, in addition to the first and second tuners 21 and 22, the navigation unit 23 and the DVD unit 24, m (m depicts plural number; for example, m denotes 4) antennas 25-1 to 25-m, an antenna switching circuit (antenna switching section) 26 and a distribution circuit 27.

The antenna 25-1 to 25-m are m in number for the first and second tuners 21 and 22, and the antenna switching circuit 26 is for switching the connection state between the plurality of antennas 25-1 to 25-m and the first and second tuners 21 and 22. Therefore, the first and second tuners 21 and 22 can also carry out the mutual switching of the antennas to be connected thereto by the antenna switching circuit 26 and, in this case, for example, the first and second tuners 21 and 22 can conduct the reception processing on at least the same-quality information such as television information and others.

The distribution circuit (display control section) 27 selects, of the source information demodulated by the first and second tuners 21 and 22 and the source information from the navigation unit 23 and the DVD unit 24, the source information to be reproduced as video picture (image) information by one for the display in the first and second display sections 3-1 and 3-2, and distributes the selected two source information to video picture (image) information and audio information. Moreover, of the source information selected and distributed by this distribution circuit 27, the video picture (image) information is outputted to the video picture (image) display processing unit 30 while the sound information is outputted to the sound output processing unit 50.

The video picture (image) display processing unit 30 is composed of first and second image quality adjusting circuits 42-1 and 42-2, first and second write circuits 43-1 and 43-2 and a VRAM (Video Random Access Memory) 44 and further includes the above-mentioned multiview display unit 3.

The first and second image quality adjusting circuits 42-1 and 42-2 are made to receive the two video picture (image) information selected and distributed by the distribution circuit 27, respectively, so as to adjust the image quality (at the display of video pictures (images)) with respect to the video picture (image) information inputted thereto. That is, the first image quality adjusting circuit 42-1 receives the data constituting the video picture (image) information to be displayed on the first display section 3-1 and processes the data constituting the inputted video picture (image) information so as to adjust the image quality at the video picture (image) display on the first display section 3-1. Likewise, the second image quality adjusting circuit 42-2 receives the data constituting the video picture (image) information to be displayed on the second display section 3-2 and processes the data constituting the inputted video picture (image) information so as to adjust the image quality at the video picture (image) display on the second display section 3-2.

The first and second write circuit 43-1 and 43-2 respectively write the data forming the video pictures (images), adjusted in image quality by the first and second image quality adjusting circuits 42-1 and 42-2, in the VRAM 44 for displaying them on the multiview display unit 3.

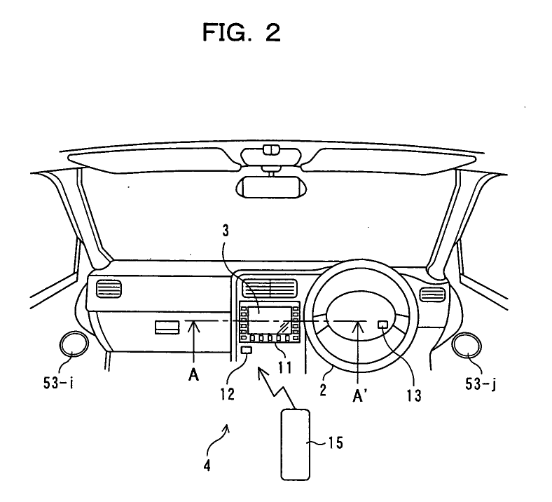

For example, as shown in FIG. 2, the multiview display unit 3 is placed at a position of a center panel in the interior of the vehicle room 4 so that displayed images are easily viewable irrespective of the seat positions at which passengers are seated in the interior of the vehicle room 4. In the vehicle room 4 shown in FIG. 2, a steering wheel section 2 is provided in front of a right side seat, and a right side seat is a driver's seat while a left side seat is a passenger seat.

Accordingly, the first display section 3-1 of the multiview display unit 3 enables a driver's seat side video picture (image) to be observed, for example, from a right side driver's seat direction as the first viewing direction while the second display section 3-2 thereof enables a passenger seat side video picture (image) to be observed, for example, from a left side passenger seat direction as the second viewing direction.

In FIG. 2, reference numeral 11 represents a control button unit provided in the center panel section, numeral 12 denotes a control button unit provided on the passenger seat side and numeral 13 designates a control button unit located in the driver's seat side steering wheel section 2 in the illustration, with the operating state of the multiview display apparatus 1 being controllable through the operations of these control buttons 11 to 13. Moreover, numeral 15 signifies a remote control terminal for conducting the operations similar to these of the control button units 11 to 13 by means of remote control.

In addition, reference numerals 53-i and 53-j (i, j: 1 to n) designate speakers functioning as mediums for outputting (reproducing) sound information, and serve as a portion of speakers 53-1 to 53-n in the later-mentioned sound output processing unit 50.

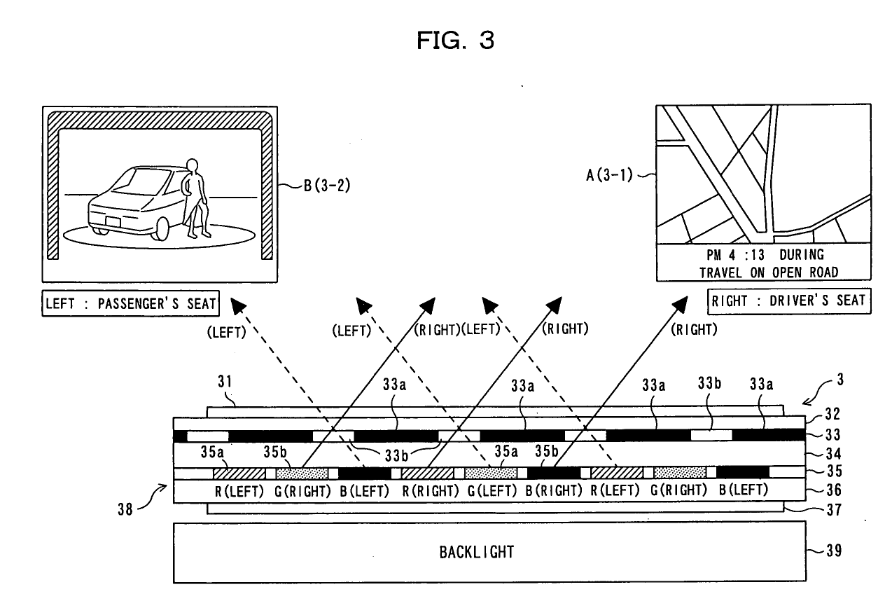

FIG. 3 is a cross-sectional view of the multiview display unit 3 shown in FIG. 2 and taken along arrows A-A′. As shown in FIG. 3, the multiview display unit 3 is equipped with a display assembly 38 comprising, from the screen plane side, a polarizing plate 31, a glass plate 32, a light interception member 33, a glass plate 34, a TFT-LCD (Thin Film Transistor-Liquid Crystal Display) 35 serving as a liquid crystal display section, the display assembly 38 including a glass plate 36 and a polarizing plate 37, and is provided with a backlight 39 on the rear side of the display assembly 38.

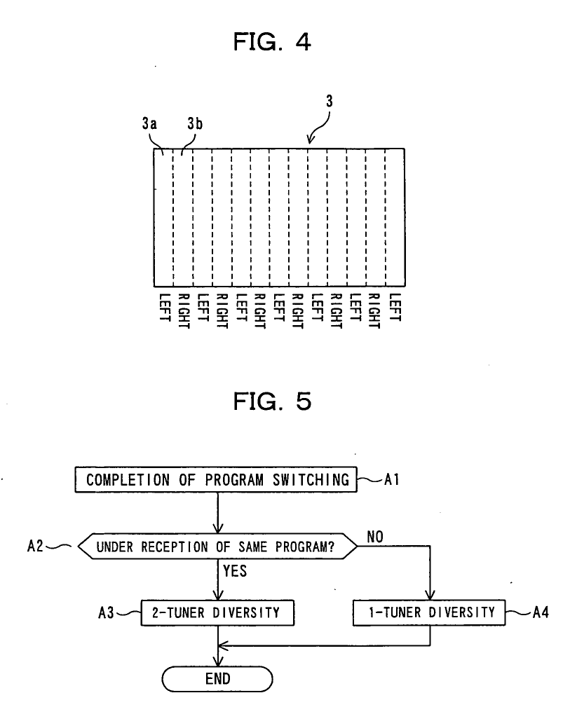

In the TFT-LCD 35, RGB light-emitting points using liquid crystal are disposed in corresponding relation to the positions of pixels constituting the screen and, for example, TFT-LCDs 35a for the display in a left-hand direction and TFT-LCDs 35b for the display in a right-hand direction are alternately disposed as shown in FIG. 3. In other words, as illustratively shown in FIG. 4, on the screen, areas 3a where the TFT-LCDs 35a are disposed for the display in the left-hand direction and areas 3b where the TFT-LCDs 35b are disposed for the display in the right-hand direction are alternately disposed in a horizontal direction of the screen.

Moreover, in the light interception member 33, together with barriers 33a for intercepting or shielding the lights from the TFT-LCDs 35a and 35b, hole portions 33b are disposed so as to permit the transmission of the lights from the TFT-LCDs 35a and 35b, and the lights emitted from the left-hand direction display TFT-LCDs 35a are outputted to the left side (i.e., the driver's seat side in the case of a vehicle with a right-hand steering wheel as shown in FIG. 2) while the lights emitted from the right-hand direction display TFT-LCDs 35b are outputted to the right side (i.e., the passenger seat side in FIG. 2).

That is, the lights emitted from the TFT-LCDs 35b disposed in the areas 3b are outputted through the hole portions 33b constituting the light interception member 33 to the driver's seat side while the lights directed at the passenger seat side are intercepted by the barriers 33a. Thus, the lights (RGB pixel lights) emitted from the TFT-LCDs 35b are outputted through the hole portions 33b, thereby forming a screen (see A in FIG. 3) to be displayed on the driver's seat side.

Likewise, the lights emitted from the TFT-LCDs 35a disposed in the areas 3a are outputted through the hole portions 33b constituting the light interception member 33 to the passenger seat side while the lights directed at the drivers seat side are intercepted by the barriers 33a. Thus, the lights (RGB pixel lights) emitted from the TFT-LCDs 35a are outputted through the hole portions 33b, thereby forming a screen (see B in FIG. 3) to be displayed on the passenger seat side.

In other words, the above-mentioned first write circuit 43-1 can write, in the corresponding address of the VRAM 44, the data for the emission from the TFT-LCDs 35b disposed in the areas 3b while the second write circuit 43-2 can write, in the corresponding address of the VRAM 44, the data for the emission from the TFT-LCDs 35a disposed in the areas 3a.

Thus, according to the data for the video picture (image) information display written in the VRAM 44, the multiview display unit 3 can make a display through the use of the first display section 3-1 and it can make a display through the use of the second display section 3-2.

In addition, when the light-emission control on the TFT-LCDs 35a forming the left-hand direction display areas 3a and the TFT-LCDs 35b forming the right-hand direction display areas 3b are independently executed through the operations of the aforesaid control button units 11 to 13, it is possible to carry out the image display made in the driver's seat direction (by the first display section 3-1) and the image display made in the passenger seat direction (by the second display section 3-2) independently of each other.

Accordingly, the aforesaid multiview display unit 3 has an arrangement (see reference numerals 31 to 34, 35b, 36, 37 and 39) of a first display section whereby a video picture (image) is observable from the first viewing direction (viewing direction from the driver's seat side) and an arrangement (see reference numerals 31 to 34, 35a, 36, 37 and 39) of a second display section whereby a video picture (image) is observable from the second viewing direction (viewing direction from the passenger seat side).

Moreover, the sound output processing unit 50 has first and second tone-quality/sound-volume adjusting circuits 51-1 and 51-2, a distribution circuit 52, speakers 53-1 to 53-n and a headphone 54.

The first and second tone-quality/sound-volume adjusting circuits 51-1 and 51-2 are made to receive the sound information of the two source information selected and distributed by the distribution circuit 7, respectively, for adjusting the tone qualities/sound volumes (at the reproduction) with respect to the sound information inputted thereto. Moreover, the distribution circuit 52 is made to distribute the n (n represents plural number) speakers 53-1 to 53-n and the headphone 54, which function as mediums for the sound output processing (i.e., reproduction), with respect to the sound information adjusted in tone quality/sound volume by the first and second tone-quality/sound-volume adjusting circuits 51-1 and 51-2. The distribution circuit 27, the first and second tone-quality/sound-volume adjusting circuits 51-1 and 51-2 and the distribution circuit 52 correspond to the sound outputting section.

That is, the sound information from the first and second tone-quality/sound-volume adjusting circuits 51-1 and 51-2 can be handled so as to correspond to the video picture (image) information to be displayed on the first and second display sections 3-1 and 3-2, respectively, and, through the use of the distribution circuit 52, these sound information are reproducible through the speakers 53-1 to 53-n and the headphone 54 which are reproduction mediums different from each other.

In particular, in a case in which video pictures (images) different from each other are displayed on the first display section 3-1 and the second display section 3-2 in the multiview display unit 3, the distribution circuit 52 can make the distribution to the speaker 53-1 to 53-n, located on the seat side where the video picture (image) is observable on each of the first and second display sections 3-1 and 3-2, so that the sound corresponding to this video picture (image) is outputted (reproduced) at a relatively large volume. In addition, the distribution can also be made such that the sound corresponding to one display section (for example, the second display section 3-2) can be outputted through only the headphone 54.

Furthermore, the detection control processing unit 60 has not only a function to capture sensor information from various types of sensors 70 such as a speed sensor 71 mounted on a vehicle for obtaining detection information to be used as a trigger for a state of operation in the multiview display apparatus 1 but also a function to receive an input of operation information with respect to the multiview display apparatus 1 and even a function to control the above-mentioned source information capturing unit 20, video picture (image) display processing unit 30 and sound output processing unit 50 on the basis of these detection information and inputted operation information.

Accordingly, the detection control processing unit 60 includes an operation inputting unit 61, a microcomputer 62 and a RAM (Random Access Memory) 63, and further includes an indicator 66.

The operation inputting unit 61 additionally has a function to accept an operation with respect to the multiview display apparatus 1 and is composed of the above-mentioned control button units 11 to 13 shown in FIG. 2. The microcomputer 62 includes a sensor detection system 64 for acquiring detection information serving as an operation trigger from the sensor information captured from the various types of sensors 70, and a control system 65 for controlling the source information capturing unit 20, the video picture (image) display processing unit 30 and the sound output processing unit 50 on the basis of the detection information from the sensor detection system 64 and the operation information inputted through the operation inputting unit 61. The functional configurations of these sensor detection system 64, control system 65 and operation inputting unit 61 form a characterized part of this apparatus, which will be described later.

The RAM 63 is for holding program information for carrying out such detection control processing in the microcomputer 62, preset information such as data, display images in the first and second display sections 3-1 and 3-2, and others in an evacuative fashion.

[A-2] About Functional Configuration of Detection Control Processing Unit 60

Secondly, a functional configuration of the detection control processing unit 60 will be described hereinbelow taking note of a case in which the distribution circuit 27 selects the source information from the first and second tuners 21 and 22.

[A-21] About Functional Configuration of Operation Inputting Unit 61

The operation inputting unit 61 of the detection control processing unit 60 is composed of the control button units 11 to 13, the remote terminal 15 and others as mentioned above and, taking note of its function, it includes a channel selection indicating unit (channel selection indicating section) 611, a video picture (image) switching indicating unit 612 and a multi-picture (image) display indicating unit 613.

In this configuration, the channel selection indicating unit 611 gives a channel selection indication (instruction) to the first tuner 21 and the second tuner 22. Moreover, the video picture (image) switching indicating unit 612 gives a video picture (image) switching indication to one display section (the display section 3-1 or the display section 3-2) in the multiview display unit 3. Still moreover, the multi-picture (image) display indicating unit 613 gives an indication to one display section 3-1 or 3-2 in the multiview display unit 3 for carrying out the display of video pictures (images) of a plurality of programs.

[A-22] About Functional Configuration of Sensor Detection System 64 in Microcomputer 62

The sensor detection system 64 constituting the microcomputer 62 of the detection control processing unit 60 is composed of a stopping state detecting unit (stopping state detecting section) 641, a traveling state detecting unit (movement (traveling) state detecting section) 642, a video picture (image) detecting unit (detecting section) 643 and a reception state detecting unit (reception state detecting section) 644. The stopping state detecting unit 641 captures sensor information on traveling speed of this vehicle from the speed sensor 71 to detect the fact of the stop of this vehicle on the basis of the traveling speed information. The traveling state detecting unit 642 is for detecting a traveling state of this vehicle on the basis of the aforesaid traveling speed information.

The video picture (image) detecting unit 643 is made to detect the difference or identification between the respective video pictures (images) displayed on the first display section 3-1 and the second display section 3-2. Concretely, together with the selection of source information in the distribution circuit 27, it detects the difference or identification between the respective video pictures according to the difference or identification between the channels selected in the first and second tuners 21 and 22.

That is, in addition to the selection of the source information from the first and second tuners 21 and 22 by the distribution circuit 27, the video picture (image) detecting unit 643 detects the fact that the respective video pictures (images) are identical to each other when the channels selected by the first and second tuners 21 and 22 are identical to each other, otherwise it detects the fact that the respective video pictures (images) are different from each other. Incidentally, it is also appropriate that the video picture (image) detecting unit 643 makes a comparison between the video picture (image) display data on the first display section 3-1 and the video picture (image) display data on the second display section 3-2, written in the VRAM 44, thereby detecting the difference or identification between the respective video pictures (images).

The reception state detecting unit 644 is made to detect reception states of the first and second tuners 21 and 22. Concretely, it detects the quantitative index values such as electric field strengths as the reception states of the first and second tuners 21 and 22 and detects the magnitudes of the detected index values corresponding to the reception states with respect to a threshold which serves as a reference as to whether or not appropriate video pictures (image) and audio reproduction are feasible.

[A-23] About Functional Configuration of Control System 65 in Microcomputer 62

Furthermore, the control system 65 constituting the microcomputer 62 of the detection control processing unit 60 is composed of a connection state change control unit (control section) 651, a video picture (image) control unit (display control section) 652, a channel selection searching unit (channel selection searching section) 653, an antenna selecting unit 654 and a sound control unit (sound control section) 655.

[A-231] About Change Control on Spatial Diversity

In this configuration, the connection state change control unit 651 controls the antenna switching unit 26 on the basis of a result of the detection by the video picture (image) detecting unit 643 to change the connection states between the antennas 25-1 to 25-m and the first and second tuners 21 and 22, thereby changing the condition of the spatial diversity.

Concretely, as shown in a flow chart of FIG. 5, in a state in which the switching of the programs displayed on the first and second display sections 3-1 and 3-2 reaches completion (step A1), when the video picture (image) detecting unit 643 detects the fact that the video pictures (images) displayed on the first and second display sections 3-1 and 3-2 are identical to each other, that is, the same programs are displayed on the first and second display sections 3-1 and 3-2 (YES route from step A2), the connection state change control unit 651 controls the antenna switching unit 26 so that the first and second tuners 21 and 22 have a common spatial diversity [“2-tuner diversity” in step A3 (the first and second tuners 21 and 22 receive the same program through different antennas 25-1 to 25-m and output received image and sound through the use of a tuner having a better reception state)].

Incidentally, it is also appropriate that the common spatial diversity employs one of the first and second tuners 21 and 22 and the antennas 25-1 to 25-m to output a signal, received through an antenna having a better reception state, from one of the first and second tuners 21 and 22.

On the other hand, in a case in which the video picture (image) detecting unit 643 detects the fact that the video pictures (images) displayed on the first and second display sections 3-1 and 3-2 are different from each other and the programs different from each other are displayed on the first and second display sections 3-1 and 3-2 (NO route from step A2), the connection state change control unit 651 controls the antenna switching unit 26 so that the first and second tuners 21 and 22 take individual spatial diversity [“1-tuner diversity” in step A4 (each of the first and second tuners 21 and 22 operates independently to output a received image and sound. Each tuner carries out the switching to an antenna to be used when the reception state becomes worse)].

In this connection, for the individual spatial diversity, it is also acceptable that the antennas 25-1 to 25-m are equally allocated to the respective tuners or that the number of antennas to be allocated to the tuner made to receive the video picture (image) on the driver's seat side is set to be smaller than the number of antennas to be allocated to the tuner made to receive the video picture (image) on the passenger seat. Alternatively, it is also possible that the diversity is not conducted on the driver's seat side (the antenna to be allocated to the tuner made to receive the driver's seat side video picture (image) is one in number) but the diversity is carried out on only the passenger seat side.

Accordingly, while the video picture (image) detecting unit 643 detects that the video pictures (images) displayed on the first display section 3-1 and the second display section 3-2 are identical to each other, the connection state change control unit 651 controls the antenna switching unit 26 so as to establish spatial diversity common to the first tuner 21 and the second tuner 22, and when the video picture (image) detecting unit 643 detects that the video pictures (images) displayed through the first tuner 21 and the second tuner 22 are not identical to each other, the connection state change control unit 651 cancels the spatial diversity common to the first tuner 21 and the second tuner 22 and controls the antenna switching unit 26 so as to accomplish individual spatial diversities with respect to the first tuner 21 and the second tuner 22.

The control of this connection state change control unit 651 enables high image quality reception and achieves the balance with multibroadcasting and promotes effective utilization of the first and second tuners 21 and 22. That is, in a case in which the first and second tuners 21 and 22 receive the same program, all the antennas 25-1 to 25-m mounted can be used for receiving the program to be displayed in the form of a video picture (image) on the first and second display sections 3-1 and 3-2, which achieves the high image quality reception. Meanwhile, when the first and second tuners 21 and 22 receive different programs, the antennas 25-1 to 25-m can be efficiently used properly for the reception in the first and second tuners 21 and 22, which enables multibroadcasting reception.

[A-232] About Channel Selection Search

Moreover, the video picture (image) control unit (display control section) 652 is made to control the video picture (image) display state on the first display section 3-1 and the video picture (image) display state on the second display section 3-2 by controlling the distribution circuit 27, and the channel selection searching unit 653 is made to carry out the channel selection search on the first tuner 21 and the second tuner 22 on the basis of a channel selection indication from the channel selection indicating unit 611. Moreover, the above-mentioned video picture (image) control unit 652 is designed to be capable of carrying out the video picture (image) switching control on the video picture (image) from the first tuner 21 and the video picture (image) from the second tuner 22 on the basis of a channel selection searching operation of the channel selection searching unit 653.

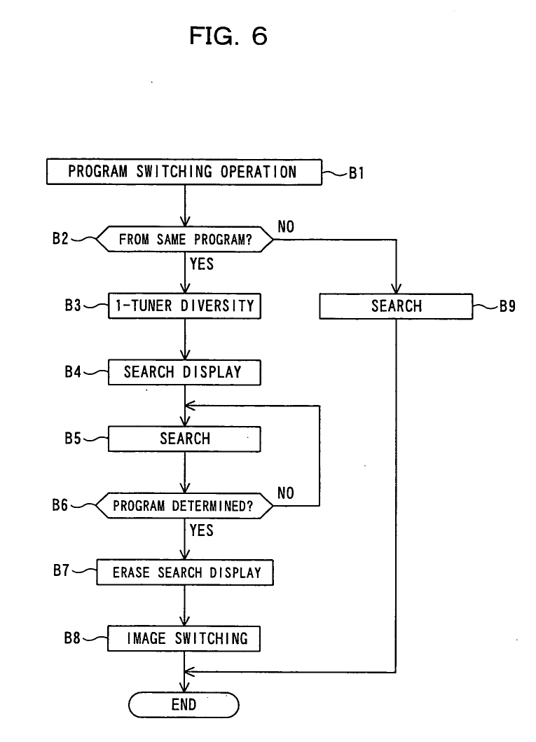

Concretely, as shown in a flow chart of FIG. 6, in a case in which the channel section indicating unit 611 implements a channel selection indication, i.e., a program switching operation (step B1), when it is an indication for the switching to a different program while the same programs are selected in the first tuner 21 and the second tuner 22 (YES route from step B2), the channel selection searching unit 653 individually carries out the allocation of the antennas 25-1 to 25-m to the respective tuners 21 and 22 so as to conduct a channel selection search on a different program with respect to one (for example, the second tuner 22) of the first tuner 21 and the second tuner 22 (“1-tuner diversity” in step B3).

Concretely, the channel selection indicating unit 611 designates the display section 3-1, 3-2 which is made to undergo the program switching and then indicates a channel after the switching. For example, if an indication is made to switch the channel in the second display section 3-2, a channel selection search can be made on the program after the switching with respect to the second tuner 22.

In addition, in the case of receiving, from the channel selection indicating unit 611, an indication for the switching from a state in which the same programs are channel-selected by the first tuner 21 and the second tuner 22 to a state in which the one display section 3-2 captures a different program as mentioned above, the connection state change control unit 651 controls the antenna switching unit 26 to cancel the common spatial diversity between the first tuner 21 and the second tuner 22 through the antennas 25-1 to 25-m for setting individual spatial diversity. In this connection, at the switching of the spatial diversity by the antenna switching unit 26 as mentioned above, for keeping better the reception situation in the present video picture (image) display side tuner 21, it is also appropriate that the allocation of the antennas 25-1 to 25-m is preferentially treated (for example, only one antenna is allocated to the channel selection search side tuner), or for upgrading the reception situation of the channel selection search side tuner, it is also acceptable to preferentially treat the allocation of the antennas 25-1 to 25-m (for example, allocating only one antenna to the video picture (image) display side tuner).

Still additionally, at this time, the video picture (image) control unit 652 executes control so that the received video picture (image) under search (video picture (image) related to the channel under the switching) is not displayed on the second display section 3-2 until the completion of channel selection search and the determination of a program) while the video picture (image) received by the selection channel before the switching (i.e., the first tuner 21 which does not undergo the channel selection search) is displayed intact. That is, the video picture (image) control unit 652 controls the distribution circuit 27 to output the received video picture (image) in the first tuner 21 to the second image quality adjusting circuit 42-2 until the completion of the channel selection search, while inhibiting the output of the received video picture (image) in the second tuner 22 to the second image quality adjusting circuit 42-2.

Accordingly, since no switching of the display on the display section 3-2 is immediately made irrespective of the program switching control by the channel selection indicating unit 611, it is possible to prevent a video picture (image) from being cut off halfway or to prevent noise from being displayed, which can prevent a video picture (image) observer from feeling visual displeasure.

That is, the distribution circuit 27 can arbitrarily set the source information to be received through the first and second tuners 21 and 22 and the video picture (image) information to be displayed on the display sections 3-1 and 3-2. In other words, an allocation is made with default so that the source information received through the first and second tuners 21 and 22 are displayed on the first and second display sections 3-1 and 3-2, respectively, while, during the channel selection search in one of the first and second tuners 21 and 22 by the channel selection searching unit 653, the display of the video picture (image) received through the other tuner, allocated with default, becomes feasible.

In addition, since the display on the display section 3-2 is not immediately switched even if the channel selection indicating unit 611 executes the program switching control, it is considered that an observer, who expects the switching of channel in response to an indication from the channel selection indicating unit 611, makes a misunderstanding that the cause of no video picture (image) switching during the channel selection search by the channel selection searching unit 653 is a trouble of the apparatus.

In this embodiment, a display to the effect of the during-channel-selection-search is made through the indicator 66 (step B4) and the channel selection search is then conducted (step B5), thus preventing the aforesaid misunderstanding. The display to the effect of the during-channel-selection-search can be made by turning a lamp on or by displaying characters on a screen.

Thus, the observer can understand the during-channel-selection-search by confirming the display on the indicator 66, thus avoiding the misunderstanding about no switching of the video picture (image) as a trouble of the apparatus. Therefore, the indicator 66 functions as a channel selection in-search displaying section to make a display to the effect of the during-channel-selection-search while the channel selection searching unit 653 carries out the channel selection search with respect to one tuner (in this case, the second tuner 22).

Following this, the channel selection search reaches completion, and the channel-selection searching unit 653 continues the channel selection search until the determination of a program to be displayed on the second display section 3-2 (step B5 through NO route from step B6). Moreover, when the channel selection search reaches completion and the program to be displayed on the second display section 3-2 is determined (YES route from step B6), the channel selection searching unit 653 cancels (erases) the display to the effect of the during-channel-selection-search made through the indicator 66 (step B7), and the video picture (image) control unit 652 switches the display on the display section 3-2 which is an object of channel selection switching indication from the channel selection indicating unit 611 (step B8).

In other words, the video picture (image) control unit 652 implements the video picture (image) switching on the display section 3-2, which is an object of channel selection switching indication, when the channel selection search on one tuner 22 by the channel selection searching unit 653 reaches completion and a display of a video picture (image) of a different program (different from the program selected by the tuner 21) becomes feasible through the use of the one tuner 22.

In this connection, in a state in which different programs are being selected through the first tuner 21 and the second tuner 22, in a case of receiving an indication for the switching to a different channel with respect to the one display section 3-2 from the channel selection indicating unit 611 (NO route from step B2), the channel selection searching unit 653 carries out a channel selection search on a tuner (for example, the second tuner 22) which has accepted the channel section indication and has received the program for the display section 3-2 (step B9). At this time, as the spatial diversity for the first and second tuners 21 and 22, the individual spatial diversity is kept intact.

In addition, since the channel selection searching unit 653 is made to carry out a channel selection search on the one tuner 22 when the same programs are being selected through the first tuner 21 and the second tuner 22, the channel selection search can be made without halfway cutting off the video picture (image) display of the program under channel selection and the search result can be stored in the preset storage unit 63, which can shorten the time needed for the program switching at the reception of the next channel selection indication.

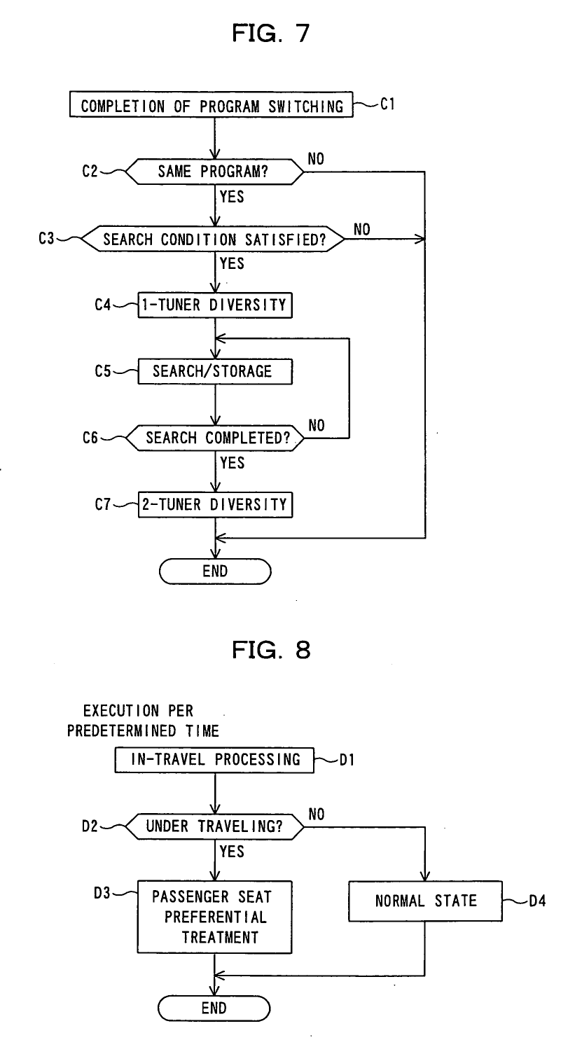

Concretely, as shown in a flow chart of FIG. 7, at the completion of the program switching, i.e., when the tuner 21, 22 undergoing the program switching receives a program after the switching (step C1), on the basis of whether a predetermined search condition is satisfied or not, the channel selection searching unit 653 makes a decision as to whether or not a channel selection search is conducted with this used as a trigger. As the search condition, it is possible to employ a condition based on whether or not a reception state detected by the reception state detecting unit 644 is a good state equal to or more than a threshold or a condition based on whether or not the stopping state detecting unit 641 detects that a vehicle equipped with this multiview display apparatus 1 is in a stopping state.

For example, if the reception state is employed as the search condition, the channel selection searching unit 653 carries out the following channel selection search. First, when the program switching reaches completion and the two tuners 21 and 22 are placed into a condition receiving the same programs, a decision is made on a reception state detected by the reception state detecting unit 644 with this used as a trigger (step C3 through YES route from step C2).

That is, when the reception state detecting unit 644 detects that the above-mentioned index value stands at a reception state equal to or higher than a threshold and shows a good reception state, a channel selection search is made on one of the first tuner 21 and the second tuner 22 (steps C4 and C5 through YES route from step C3). However, in a case in which the two tuners 21 and 22 do not receive the same programs, or if the reception state detecting unit 644 detects that the aforesaid index value stands at a reception state lower than the threshold and shows no good reception state, the channel selection searching unit 653 does not carry out the channel selection search (No route from step C2, NO route from step C3).

Furthermore, in a case in which a stopping state of a vehicle is employed as the search condition, the channel selection searching unit 653 carries out the following channel selection search. First, when the program switching reaches completion and the two tuners 21 and 22 are placed into a state receiving the same programs, with this used as a trigger, a decision is made as to whether or not a traveling state of the vehicle detected by the stopping state detecting unit 641 takes a stopping state (step C3 through YES route from step C2).

That is, when the stopping state detecting unit 641 detects that the vehicle is in a stopping state, one of the first tuner 21 and the second tuner 22 (step C4 through YES route from step C3) undergoes a channel selection search (step C5, NO route from step C6). However, if the stopping state detecting unit 641 detects that the vehicle is not in a stopping state, the channel selection searching unit 653 does not carry out the channel selection search (NO route from step C3).

In a case in which the above-mentioned channel selection search is conducted by the channel selection searching unit 653, of the antennas 25-1 to 25-m, the antenna selecting unit 654 selects an antenna for the image to be displayed (for example, antenna connected to the tuner where no channel selection search is conducted at present) and selects an antenna other than the display image antenna for the channel selection search. Moreover, according to this selection by the antenna selecting unit 654, the antenna switching unit 26 switches the antennas 25-1 to 25-m to be connected to the first and second tuners 21 and 22.

For example, if, of the first and second tuners 21 and 22 selecting the same programs, a channel selection search is made on the second tuner 22, the antenna switching unit 26 connects the first tuner 21 to the aforesaid display image antenna and connects the second tuner 22 to the channel selection search antenna.

The result of the channel selection search by the channel selection searching unit 653 is stored in the RAM 63. Thus, the search result stored in the RAM 63 is used at the next channel selection switching, which can shorten the time needed for the switching.

In this way, when the channel selection search by the channel selection searching unit 653 reaches completion (YES route from step C6), the connection state change control unit 651 controls the antenna switching unit 26 to set the antennas 25-1 to 25-m for the former spatial diversity, i.e., the spatial diversity common to the first and second tuners 21 and 22 (step C7).

For the search according to the achievement of the above-mentioned search condition, it is also possible to effect frequency diversity for searching a broadcasting station which broadcasts the program with the same contents, or to combine the spatial diversity and the frequency diversity.

[A-233] About Display Screen Switching Function

With respect to the display on the multiview display unit 3 shown in FIG. 1, it is possible to make a difference between the displays on the first and second display sections 3-1 and 3-2 according to whether or not a vehicle, on which this multiview display apparatus 1 is mounted, is in a traveling state.

Concretely, as shown in a flow chart of FIG. 8, the traveling state detecting unit 642 captures the traveling speed information, which is sensor information from the speed sensor 71, at intervals of predetermined time to detect, on the basis of the captured traveling speed information, whether this vehicle is in a traveling state (step D1).

At this time, if the vehicle is in a stopping state, a difference (superiority or inferiority) is not made between the video picture (image) displays on the first and second display sections 3-1 and 3-2, and a normal display mode is taken (step D4 through NO route from step D2). On the other hand, if the vehicle is in a traveling state, the video picture (image) display on the second display section 3-2 observable from the passenger seat side is preferentially treated in comparison with the video picture (image) on the first display section 3-1 (step D3 through YES route from step D2). Thus, the reception sensitivity for the display on the first display section 3-1 observable from the driver's seat side is set to be relatively lowered as one mode of the display control during the traveling.

Concretely, when the traveling state detecting unit 642 detects that the vehicle is in a traveling state, the video picture (image) control unit 652 carries out the video picture (image) switching (through the control on the distribution circuit 27) so that the second display section 3-2 forming a display observable in viewing directions other than the driver's seat displays a video picture (image) from a tuner whose reception state is equal to or higher than a threshold.

Moreover, in a case in which the first and second display sections 3-1 and 3-2 display video pictures (images) of broadcasting programs received through the first and second tuners 21 and 22, respectively, when the traveling state detecting unit 642 detects a traveling state of the vehicle, through the control of the antenna switching unit 26 by the antenna selecting unit 654, an allocation distribution of the antennas 25-1 to 25-m is set so that the reception sensitivity of the second tuner 22 receiving a video picture (image) of a broadcasting program to be displayed on the second display section 3-2 becomes higher than the reception sensitivity of the first tuner 21. Concretely, the reception sensitivity is upgraded by increasing the number of antennas 25-1 to 25-m to be connected to the second tuner 22 which is made to receive the broadcasting program displayed on the second display section 3-2.

Incidentally, it is also acceptable that, with respect to a viewing from the driver's seat side during the traveling, the video picture (image) display control unit 30 is controlled so as to display an image under control, different from the received video picture (image), and output only a sound. In this case, since the reception sensitivity at the driver's seat can be lowered in comparison with the passenger seat side which displays the received video picture (image), it is also possible to decrease the number of antennas 25-1 to 25-m to be allocated to the first tuner 21 corresponding to the driver's seat side as mentioned above (for example, the number of antennas to be allocated to the first tuner 21 is set at one).

Moreover, it is also acceptable that, when the reception state detecting unit 644 detects a reception state lower than a threshold in any one of the first tuner 21 and the second tuner 22, the video picture (image) control unit 652 makes the switching to a video picture (image) from the tuner other than the tuner whose reception state is lower than the threshold.

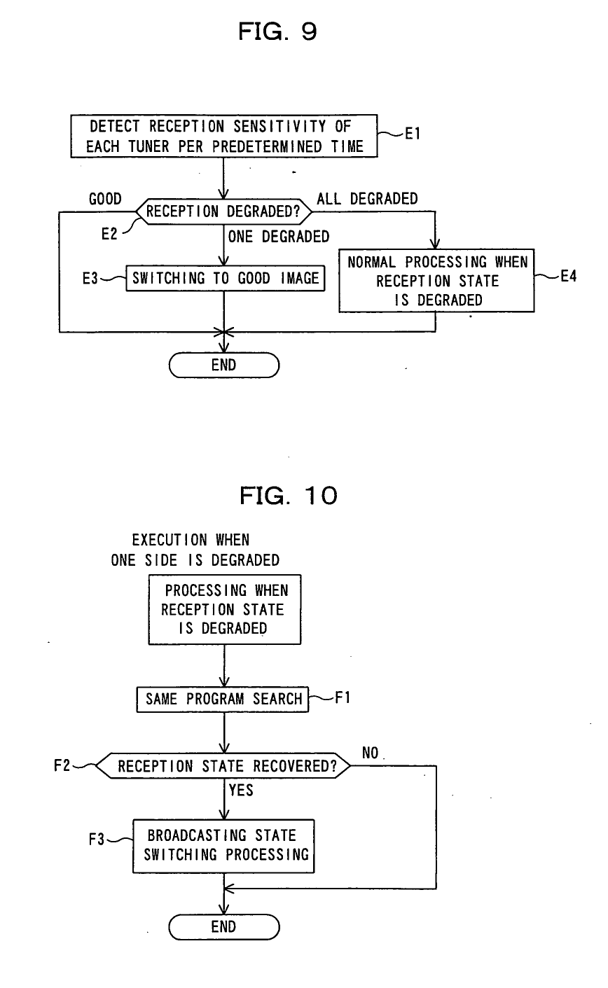

Concretely, as shown in a flow chart of FIG. 9, the video picture (image) control unit 652 receives a result of the detection of the reception states of the first and second tuners 21 and 22 from the reception state detecting unit 644 (step E1) and, when recognizing that only one tuner gets worse, makes the switching from the display on the display section (for example, the first display section 3-1 displaying a video picture (image) from the first tuner 21), which displays a video picture (image) from the tuner whose reception state gets worse, to a display of a video picture (image) from the second tuner 22 whose reception state is good (step E3 through “one degraded” route from step E2).

In addition, if the reception states of the first and second tuners 21 and 22 received are good, the reception states are continued intact (“good” route from step E2), and when both the reception states of the first and second tuners 21 and 22 get worse, for example, the video picture (image) control unit 652 carries out the normal processing when the reception states are degraded, such as displaying a still picture (step E4 through “all degraded” route from step E2).

In a case in which the reception sensitivity of the first tuner 21 having the degraded reception state is recovered after the display on the first display section 3-1 is switched so as to display the video picture from the second tuner 22 whose reception state is good, the video picture (image) control unit 652 executes the control as follows so as to display the former video picture (image) received through the first tuner 21 as the display on the first display section 3-1.

Concretely, as shown in a flow chart of FIG. 10, when the reception state detecting unit 644 detects a reception state lower than the threshold in one (for example, first tuner 21) of the first tuner 21 and the second tuner 22, the channel selection searching unit 653 searches the same program as the program from the tuner 22 other than the tuner 21, which has the reception state lower than the threshold, with respect to the tuner 21 having the reception state lower than the threshold (step F1).

Moreover, the video picture (image) control unit 652 displays a received video picture (image) from the second tuner 22 on the first display section 3-1 until the reception state of the first tuner 21, which has had the reception state lower than the threshold, becomes equal to more higher than the threshold and is recovered (NO route from step F2) and, when the reception state of the first tuner 21 exceeds the threshold and reaches a recovered condition (YES route from step F2), the video picture (image) control unit 652 executes the switching control to a video picture (image) from the first tuner 21, which has had the reception state lower than the threshold, with respect to the first display section 3-1 (step F3).

Still moreover, in a case in which the aforesaid video picture (image) switching indicating unit 612 gives a video picture (image) switching indication to one (for example, the first display section 3-1) of the first and second display sections 3-1 and 3-2 of the multiview display unit 3, the video picture (image) control unit 652 is designed to carry out the display to be made by the other display section 3-2 through the use of the one display section 3-1 in the multiview display unit 3. Thus, according to the indication from the video picture (image) switching indicating unit 612, in the multiview display section 3, the video picture (image) information, which is being displayed on the other display section 3-2, can be displayed on the one display section 3-1.

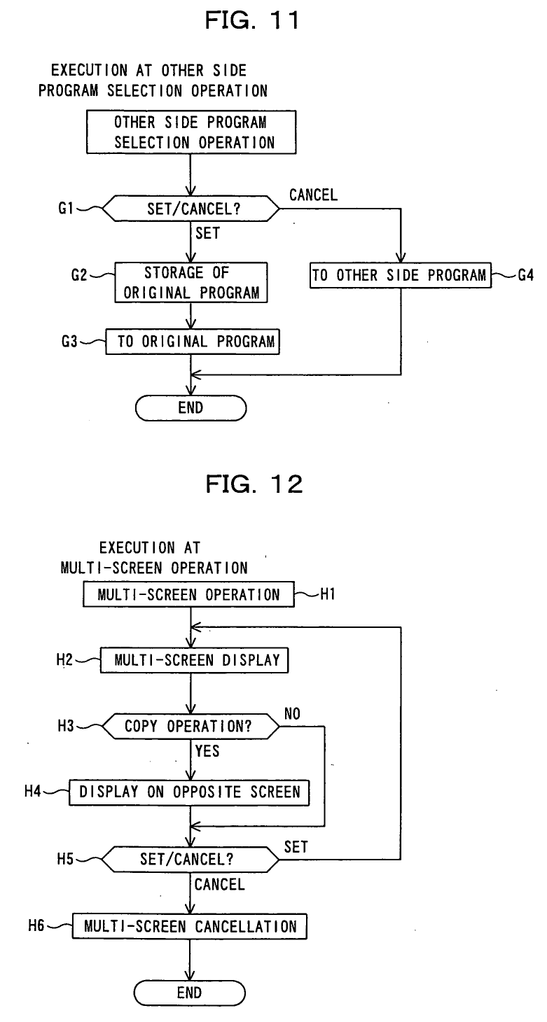

Concretely, as shown in a flow chart of FIG. 11, in a case in which, for example, a video picture (image) switching indication to the first display section 3-1 is set through the video picture (image) switching indicating unit 612 (“set” route from step G1), the program information (channel selection information and others) on the video pictures (images), which have been displayed up to now on the first display section 3-1 which is an object of switching, is stored in the RAM 63 (step G2), and the video picture (image) control unit 652 controls the distribution circuit 27 to display the program (other side program) displayed on the second display section 3-2 (step G3).

In addition, when the setting of the video picture (image) switching indication to, for example, the first display section 3-1 is canceled through the video picture (image) switching indicating unit 612 (“cancel” route from step G1), the video picture (image) of the former program before the video picture (image) switching is displayed on the basis of the former program information stored in the RAM 63 (step G4).

When the video picture (image) switching can be made in this way, if a broadcasting program is received at a high sensitivity on the other side display section, the other side broadcasting program can be simply and promptly displayed and confirmed on its own side display section.

Still additionally, upon receipt of an indication (instruction) from the multi-picture (image) display indicating unit 613 for a video picture (image) display of a plurality of programs with respect to one (for example, the first display section 3-1) of the first and second display sections 3-1 and 3-2 of the multiview display unit 3, the video picture (image) control unit 652 can carry out the control so that the video pictures (images) of the plurality of programs are displayed on this one display section 3-1.

Concretely, as shown in a flow chart of FIG. 12, upon receipt of an indication through the multi-picture (image) display indicating unit 613 for the video picture (image) display of a plurality of programs with respect to, for example, the first display section 3-1 (step H1), the video picture (image) control unit 652 controls the distribution circuit 27 so that the video picture (image) to be displayed on the first display section 3-1 becomes a video picture (image) display of a plurality of programs (multi-image display) (step H2).

At this time, the program information (channel selection information and others) on the video picture (image) which has been displayed up to now on the first display section 3-1 is stored in the RAM 63 through the video picture (image) control unit 652. Moreover, under the control of the video picture (image) control unit 652, the distribution circuit 27 divides the first display section 3-1 into a plurality of blocks, and generates video picture (image) information so that a program video picture (image) is displayed in each block.

In a case in which the multi-image display is made on the one display section 3-1 as mentioned above, when a copy operation for the display on the one display section 3-1 is inputted through the operation inputting unit 61 to the other display section (second display section 3-2), the copy of the display on this one display section 3-1 is displayed on the other display section 3-2 (step H4 through YES route from step H3). Thus, the second display section 3-2, which receives the copy display, can produce the multi-screen for a relatively short time, thereby shortening the interruption of the program looking and listening.

Furthermore, the multi-image display on the first display section 3-1, switched according to the indication from the multi-picture (image) display indicating unit 613, continues until an operation for the cancellation of the multi-picture (image) display is conducted through the multi-picture (image) display indicating unit 613 (step H2 through “set” route from step H5). Still furthermore, in response to the cancellation operation, the first display section 3-1 cancels the multi-image display and displays the video picture (image) of the former program before the video picture (image) switching on the basis of the former program information stored in the RAM 63 (step H6 through “cancel” route from step H5).

[A-234] About Sound Control

Meanwhile, the sound control unit 655 is for controlling the sounds to be outputted from the plurality of speakers 53-1 to 53-n or the headphone 54.

For example, although, when the reception state detecting unit 644 detects a reception state lower than a threshold in one of the first tuner 21 and the second tuner 22, the video picture (image) control unit 652 is made to be capable of carrying out the switching to a video picture (image) from the tuner other than the tuner having the reception state lower than the threshold (see the flow chart of FIG. 9), the sound control unit 655 is also designed to be capable of executing the switching control on the sound (voice) to be outputted through the speakers 53-1 to 53-n so as to correspond to this video picture (image) switching. This avoids the sound output in a state where the reception state gets worse and prevents the viewer from feeling uncomfortable.

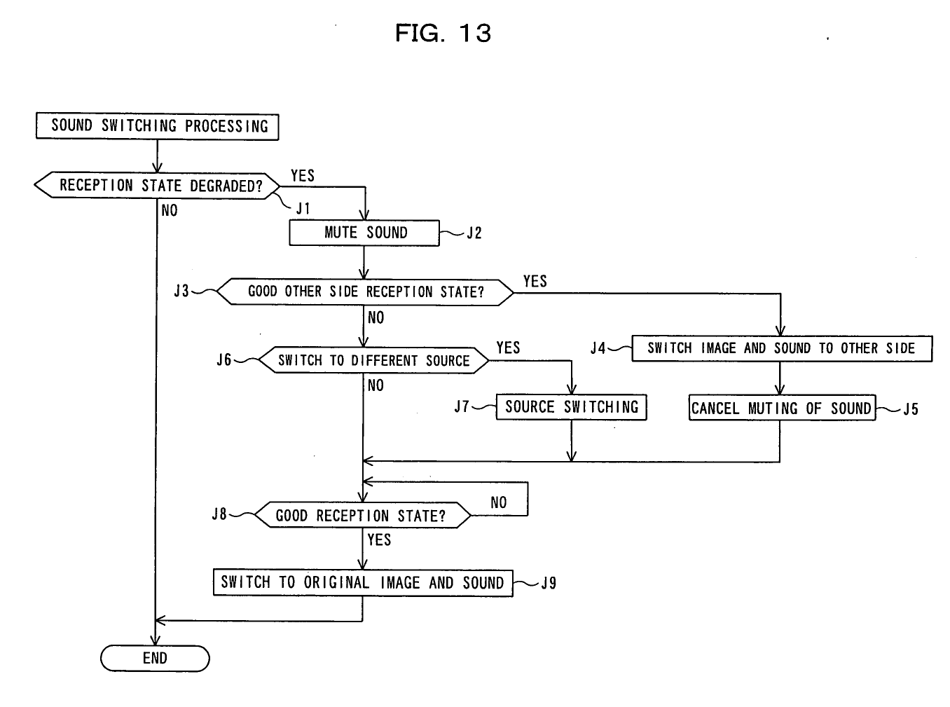

Concretely, as shown in a flow chart of FIG. 13, when the reception state detecting unit 644 detects a reception state lower than a threshold in one (for example, the first tuner 21) of the first tuner 21 and the second tuner 22, the sound control unit 655 mutes the sound from the first tuner 21 having the reception state lower than the threshold by controlling the first tine-quality/sand-volume adjusting circuit 51-1 (step J2 through YES route from step J1).

At this time, when the reception state detecting unit 644 confirms that the reception state of the second tuner 22 which receives the video picture (image) information to be displayed on the second display section 3-2 forming the other side display section is equal to or higher than the threshold and is a good condition, combined with the video picture (image) and the sound, the information (video picture (image) and sound) from the other side second tuner 22 is displayed/outputted (step J4 through YES route from step J3) and the sound muting is canceled by controlling the first tine-quality/sand-volume adjusting circuit 51-1 (step J5).

That is, the video picture (image) control unit 652 controls the video picture (image) switching to display a video picture (image) from the second tuner 22 with respect to the first display section 3-1 which has displayed the video picture (image) from the first tuner 21 lower than the threshold. Moreover, the sound control unit 655 carries out the sound switching by controlling the distribution circuit 52 for displaying (outputting) the sound from the second tuner 22 with respect to the speakers 53-1 to 53-n (allocated to correspond to the video pictures (images) from the first display section 3-1) which have displayed (outputted) the sound from the first tuner 21.

In addition, the sound from the navigation unit 23 or the DVD unit 24, which is an input source unit other than the first and second tuners 21 and 22, is displayed (outputted) when the reception state detecting unit 644 confirms that the reception state of the second tuner 22 which receives the video picture (image) information to be displayed on the second display section 3-2 forming the other side display section is lower than the threshold and is a good condition (NO route from step J3, step J7 through YES route from step J6).

In this connection, it is also acceptable that, when a reception state lower than the threshold is detected in one of the first tuner 21 and the second tuner 22, the tuner having the reception state lower than the threshold is switched to an input source unit other than the first and second tuners 21 and 22.

Meanwhile, in a case in which an input source unit other than the first and second tuners 21 and 22 is not connected to the speakers 53-1 to 53-n or the headphone 54 as mentioned above so that difficulty is encountered in displaying (outputting) the sound from the input source unit other than the first and second tuners 21 and 22, a muted state is kept until the reception state of the first tuner 21 recovers up to a good condition (NO route from step J6, NO route from step J8).

Moreover, also in the case of the above-mentioned switching to the video picture (image)/sound from the second tuner 22 having a good condition (steps J4, J5), or in the case of the switching to the sound from the input source unit other than the first and second tuners 21 and 22 (step J7), when the reception state of the first tuner 21 which has displayed (outputted) the sound before the switching is recovered up to a good condition, the video picture (image) control unit 652 and the sound control unit 655 carry out the switching to the output of the video picture (image) information and the sound information from the first tuner 21, which are the former video picture (image) and sound (step J9 through YES route from step J8).

Furthermore, as a different control mode at the degradation of reception state, if a state where the reception state detecting unit 644 detects a reception state lower than the threshold in one (for example, the first tuner 21) of the first tuner 21 and the second tuner 22 continues for a predetermined period of time, the sound control unit 655 can control the first tone-quality/sound-volume adjusting unit 51-1 with respect to the sound from the first tuner 21 having the reception state lower than the threshold so as to mute the sound corresponding to the video picture (image) from this first tuner 21.

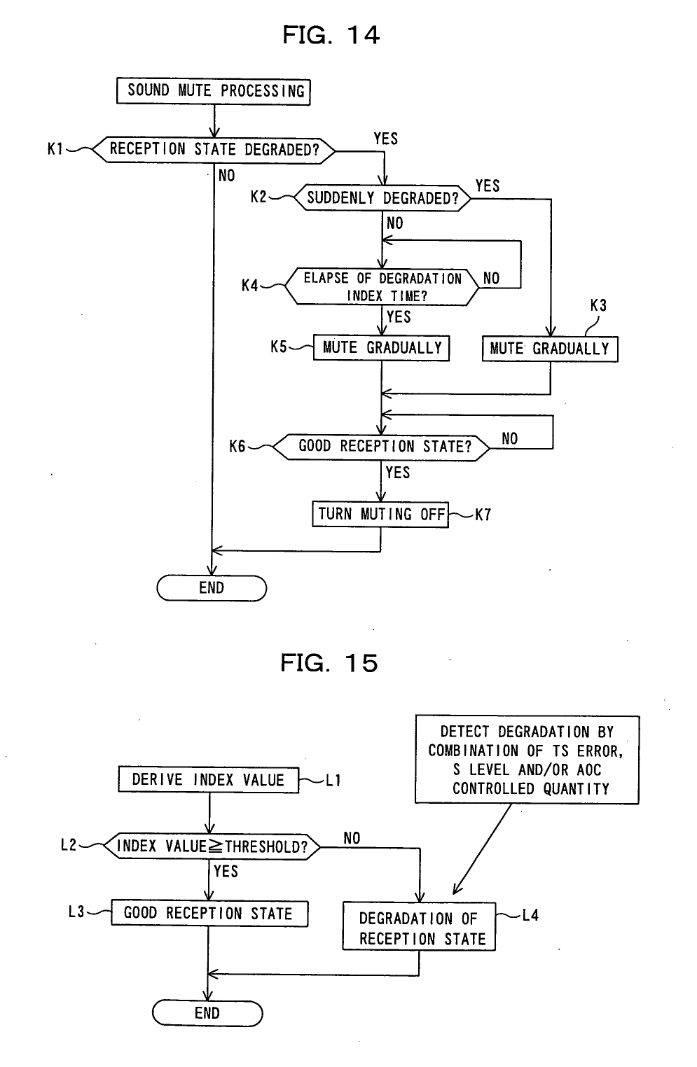

Concretely, as shown in a flow chart of FIG. 14, in a case in which the reception state detecting unit 644 detects a reception state lower than the threshold in one (for example, the first tuner 21) of the first tuner 21 and the second tuner 22 (YES route from step K1), if the variation of the reception state detected by the reception state detecting unit 644 takes a sudden change, the sound control unit 655 immediately executes the control so as to mute the sound from this first tuner 21 (step K3 through YES route from step K2).

On the other hand, if the variation of the reception state detected by the reception state detecting unit 644 is no sudden change (NO route from step K2) and a reception state lower than the threshold continues for a predetermined period of time, the sound control unit 655 gradually mutes the sound from the first tuner 21 (step K5 through YES route from step K4).

In this connection, in both the case in which the sound immediately muted in response to the sudden variation of the reception state as mentioned above (step K3) and the case in which the sound is gradually muted when the degraded reception state continues for the predetermined period of time (step K5), if the reception state of the first tuner 21 which has displayed the sound before the switching is recovered up to a good condition, the sound control unit 655 makes the switching to the display (output) of the sound information, i.e., the former sound, from the first tuner 21 (step K7 through YES route from step K6).

In other words, when the reception state of the tuner (in this case, the first tuner 21) having a reception state lower than the threshold becomes equal to or higher than the threshold, the sound control unit 655 makes the switching to the sound from the tuner (first tuner 21) which has had the reception state lower than the threshold.

After a state (point of time) where the reception state detecting unit 644 detects a reception state lower than the threshold in one (for example, the first tuner 21) of the first tuner 21 and the second tuner 22, when the reception state detecting unit 644 detects a state lower than a different threshold, higher in degree of reception state degradation, within a predetermined period of time, the sound control unit 655 can also mute the sound corresponding to the video picture (image) from the tuner (for example, the first tuner 21) having a reception state lower than the different threshold.

That is, even in a case in which the variation of the reception state detected by the reception state detecting unit 644 is not a sudden change, when the index value of the reception state becomes lower than a second threshold, which is the different threshold for the decision on the degradation of the reception state with respect to the aforesaid threshold, prior to the decision on the continuation of the predetermined period of time, the sound control unit 655 can mute the sound immediately.

The above-mentioned reception state detecting unit 644 can be made to detect the reception state on the basis of a combination of a TS (Transport Stream) error signal, an S (Signal) level and an AGC (Automatic Gain Control) voltage.

That is, as shown in a flowchart of FIG. 15, the reception state detecting unit 644 obtains an index value of a reception state on the basis of a TS error signal, an S level and an AGC voltage (step L1) and makes a comparison between this index value and a threshold set in advance as a reference for making a decision as to whether or not it is a reception state where an appropriate video picture (image) or sound is reproducible. If the comparison result shows that the obtained index value is equal to or higher than this threshold, a decision can be made that the reception state is a good condition (step L3 through YES route from step L2) while, if the comparison result shows that the obtained index value is lower than this threshold, a decision can be made that the reception state does not reach a good condition (step L4 through NO route from step L2).

The index value to be obtained can be derived to stand at a lower value when a TS error occurs, when an S level drops or when the AGC level controlled value increases.

[A-3]

As described above, the multiview display apparatus 1 according to the embodiment of the present invention can provide, through the control of the connection state change control unit 651, advantages of achieving the balance between the high image quality reception and the multibroadcasting reception, and properly using the antennas 25-1 to 25-m efficiently for the reception in the first and second tuners 21 and 22 while effecting the effective utilization of the first and second tuners 21 and 22, thus accomplishing the multibroadcasting reception smoothly.

[B] Others

It should be understood that the present invention is not limited to the above-described embodiment, and that it is intended to cover all changes and modifications of the embodiment of the invention herein which do not constitute departures from the spirit and scope of the invention.

For example, it is also appropriate that the aforesaid control system 65 of the microcomputer 62 further includes an antenna allocation specifying unit (antenna allocation specifying section) 656 made to specify the allocation of the plurality of antennas 25-1 to 25-m to the first and second tuners 21 and 22 according to operating states of the first and second tuners 21 and 22. This enables the optimum antenna allocation and permits the effective antenna utilization. For example, when more antennas are allocated to the tuner 21, 22 which is required to provide a relatively high reception quality, an upgraded reception is achievable.

Incidentally, the antenna allocation specifying unit 656 can also specify the allocation of the plurality of antennas 25-1 to 25-m to the first and second tuners 21 and 22 according to movement states as mentioned above.

In addition, although in the detailed description of the above-described embodiment the multiview display apparatus is mounted on a car, the present invention is not limited to this but, naturally, it is also possible to mount it on a vehicle other than the car or to install a place other than the vehicle.

Still additionally, although the multiview display unit 3 described above in detail is configured to include, on the same display plane, the first display section 3-1 where a video picture (image) is observable from the first viewing direction and the second display section 3-2 where a video picture (image) is observable from the second viewing direction, the present invention is not limited to this but, naturally, it is also possible to make a configuration whereby video pictures (images) are independently observable from three or more viewing directions on the same display plane.

Yet additionally, it is also acceptable to mount two or more tuners according to the number of video pictures (images) independently observable.

Moreover, also in the case of the employment of a plurality of display sections observable on different display planes, a technical feature of the present invention is applicable thereto. Concretely, this comprises an antenna switching section switching connection states between a plurality of tuners and a plurality of antennas, a detection section detecting the difference or identification between a first broadcasting program corresponding to an individual image to be displayed on one of a plurality of display sections and a second broadcasting program corresponding to an individual image to be displayed on, of the plurality of display sections, a display section other than the aforesaid one display section, and a control section controlling the antenna switching section on the basis of a result of the detection by the detection section.

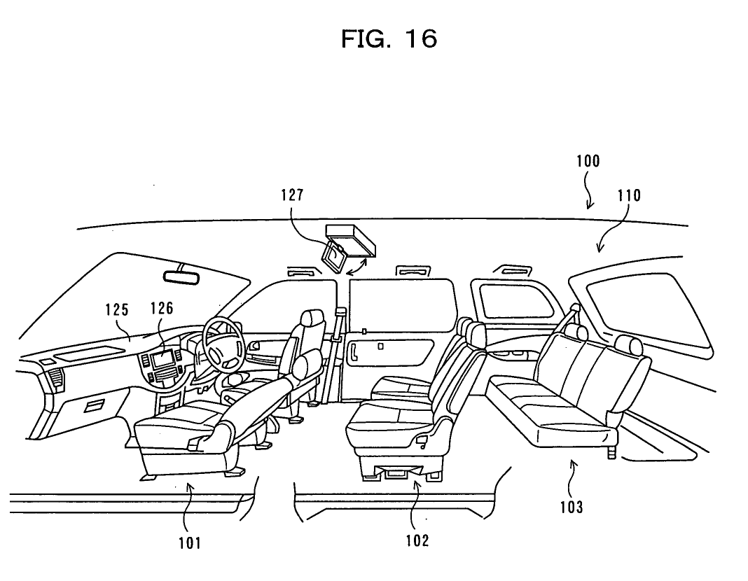

For example, as shown in FIG. 16, in a vehicle (mobile body) 100 in which a front monitor 126 and a rear monitor 127 are disposed, a characterized configuration according to the invention of this application is also applicable thereto. The vehicle 100 equipped with a first-row seat 101, a second-row seat 102 and a third-row seat 103 in a vehicle room 110. And the front monitor 126 serving as a display unit for a passenger who is seated on the first-row seat 101 is provided at a generally central portion of an instrument panel 125 in the interior of the vehicle room 110 while the rear monitor 127 acting as a display unit for passengers who are seated on the second-row seat 102 and on the third-row seat 103 is provided at a generally vehicle-width-direction central portion of the roof of the vehicle room 110 at a rear section of the first-row seat 101 (roof on a front and upper side of the second-row seat 102.

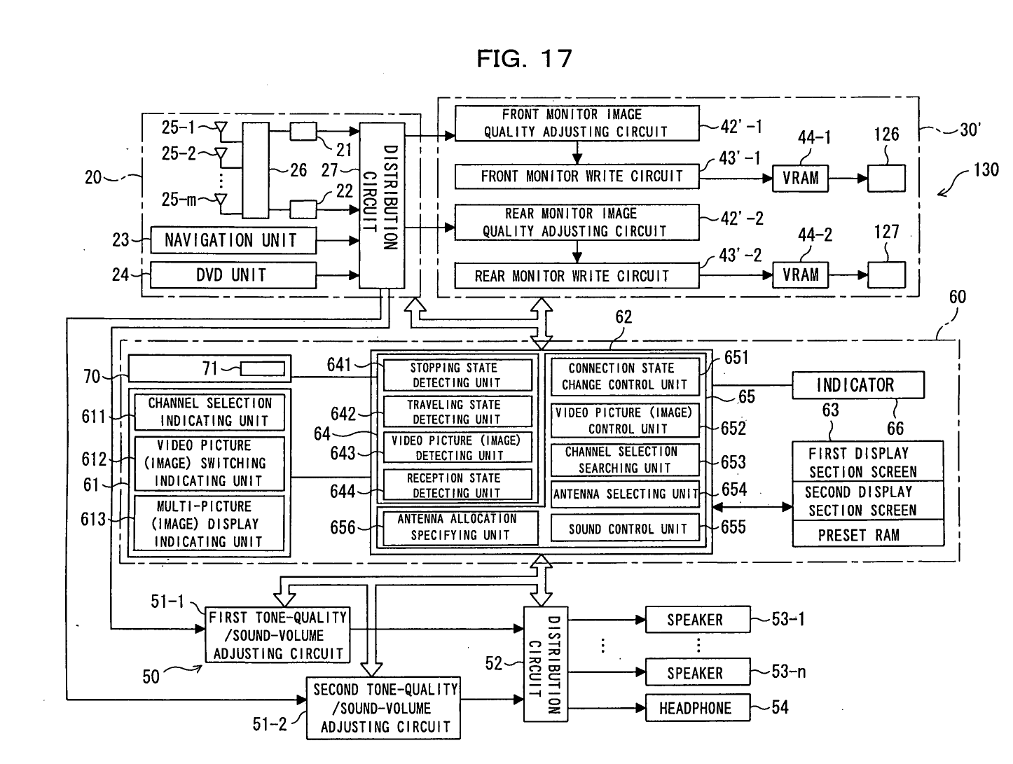

For example, as shown in FIG. 17, this makes a display apparatus 130 serving as a receiving apparatus. The display apparatus 130 shown in FIG. 17, mounted on a vehicle such as a car, is designed to set the antenna allocation between a plurality of antennas 25-1 to 25-m and first and second tuners 21 and 22 and capture source information (information on the source of video picture (image) and sound display) from the first and second tuners 21 and 22 or source information from a navigation unit 23 and a DVD unit 24, which correspond to an input source, for displaying them through the front monitor 126, the rear monitor 127, speakers 53-1 to 53-n, a headphone 54 or the like.

The display apparatus 130 shown in FIG. 17 differs from the above-described multiview display apparatus 1, which is the receiving apparatus shown in FIG. 1, in a configuration of a video picture (image) display processing unit 30′ which is made to conduct the display processing on video picture (image) information forming source information, and the other configuration is basically similar to that shown in FIG. 1. The same reference numerals as those used in FIG. 1 designate substantially similar sections.

In this configuration, different from that described above with reference to FIG. 1, the video picture (image) display processing unit 30′ includes, in place of the multiview display unit 3, a plurality of (in this case, two) different display units, i.e., a front monitor 126 and a rear monitor 127, and image quality adjusting circuits 42′-1, 42′-2 and write circuits 43′-1, 43′-2 respectively provided for the front monitor 126 and the rear monitor 127, and a VRAM (Video Random Access Memory) 44.

The front monitor image quality adjusting circuit 42′-1 receives video picture (image) information for the display on the front monitor 126, selected and distributed by the distribution circuit 27, to adjust the image quality of the inputted video picture (image) information (at the video picture (image) display). Likewise, the rear monitor image quality adjusting circuit 42′-2 receives video picture (image) information for the display on the rear monitor 127, selected and distributed by the distribution circuit 27, to adjust the image quality of the inputted video picture (image) information (at the video picture (image) display).

That is, the front monitor image quality adjusting circuit 42′-1 receives the data constituting the video picture (image) information to be displayed on the front monitor 126 so as to process the inputted data constituting the video picture (image) information for adjusting the image quality at the display of the video picture (image) on the front monitor 126. Likewise, the rear monitor image quality adjusting circuit 42′-2 receives the data constituting the video picture (image) information to be displayed on the rear monitor 127 to process the inputted data constituting the video picture (image) information for adjusting the image quality at the display of the video picture (image) on the rear monitor 127.

In addition, the front monitor write circuit 43′-1 writes the data constituting the video picture (image) information, adjusted in image quality by the front monitor image quality adjusting circuit 42′-1, in the VRAM 44-1 for the display on the front monitor 126. Similarly, the rear monitor write circuit 43′-2 writes the data constituting the video picture (image) information, adjusted in image quality by the rear monitor image quality adjusting circuit 42′-2, in the VRAM 44-2 for the display on the rear monitor 127.

Also in the display apparatus 130 thus configured, as in the case of the above-described apparatus shown in FIG. 1, the detection control processing unit 60 has a function to capture sensor information from various types of sensors 70 such as the speed sensor 71 mounted on the vehicle 100 for acquiring detection information to be used as a trigger for an operating state of the display apparatus 130 and has a function to receive the input of an operation for the display apparatus 130, and controls the source information capturing unit 20, the video picture (image) display processing unit 30′ and the sound output processing unit 50.

In particular, as well as the above-described embodiment shown in FIG. 1, through the control of the connection state change control unit 651, it is possible to provide advantages of achieving the balance between the high image quality reception and the multibroadcasting reception, and properly using the antennas 25-1 to 25-m efficiently for the reception in the first and second tuners 21 and 22 while effecting the effective utilization of the first and second tuners 21 and 22, thus accomplishing the multibroadcasting reception smoothly.

Furthermore, the disclosure of the above-described embodiments enables a so-called person skilled in the art to manufacture the apparatus according to the present invention.

What is claimed is:

1. A receiving apparatus comprising:
a display section displaying individual images with respect to a plurality of viewing directions on the same screen;
a plurality of tuners;
a plurality of antennas connected to said plurality of tuners;
an antenna switching section switching a connection state between said plurality of tuners and said plurality of antennas;
a detection section detecting a difference or identification between a first broadcast program corresponding to an individual image with respect to one viewing direction and a second broadcast program corresponding to an individual image with respect to at least one viewing direction other than said one viewing direction; and
a control section controlling said antenna switching section on the basis of a result of the detection by said detection section.

2. The receiving apparatus according to claim 1, wherein, when said first broadcast program and said second broadcast program are identical to each other, said control section controls said antenna switching section so that common diversity control is executed through the use of a first tuner receiving said first broadcast program and/or a second tuner receiving said second broadcast program and, when said first broadcast program and said second broadcast program are different from each other, said control section controls said antenna switching section so that diversity control is individually executed through the use of each of said first tuner and said second tuner.

3. The receiving apparatus according to claim 2, further comprising a display control section controlling the switching between an individual display state in which a broadcast program received through said first tuner is set as said first broadcast program to be displayed on said display section while a broadcast program received through said second tuner is set as said second broadcast program to be displayed on said display section and a common display state in which a broadcast program received by said first tuner or said second tuner is set as said first broadcast program and said second broadcast program to be displayed on said display section.

4. The receiving apparatus according to claim 3, further comprising a channel selection indicating section giving a channel selection indication to at least one tuner and a channel selection searching section giving an indication for a channel selection search to at least one of said plurality of tuners on the basis of said channel selection indication so that said display control section executes the switching control on the basis of a channel selection operation of at least said one tuner according to said indication for channel selection search from said channel selection searching section.

5. The receiving apparatus according to claim 4, wherein, in a case in which a channel selection indication from said channel selection indicating section is detected when said first broadcast program and said second broadcast program are identical to each other, said channel selection searching section gives an indication for a channel selection search to one of said first tuner and said second tuner, and said display control section executes said switching control at the time that said channel selection search by said one tuner reaches completion and a broadcast program received by said one tuner reaches a display-possible condition.

6. The receiving apparatus according to claim 4, wherein, when said first broadcast program and said second broadcast program are identical to each other, said channel selection searching section gives an indication for a channel selection search to one of said first tuner and said second tuner.

7. The receiving apparatus according to claim 6, further comprising a reception state detecting section detecting a reception state of said first tuner or said second tuner so that said channel selection searching section gives an indication for a channel selection search to said one tuner when said reception state detected by said reception state detecting section is equal to or higher than a predetermined threshold.

8. The receiving apparatus according to claim 6, further comprising a stopping state detecting section detecting a stopping state of a mobile object, on which said receiving apparatus is mounted, so that said channel selection searching section gives an indication for a channel selection search to said one tuner when said stopping state detecting section detects a stopping state of said mobile object.

9. The receiving apparatus according to claim 3, further comprising a reception state detecting section detecting reception states of said first tuner and said second tuner so that said display control section executes switching control to said common display state when, in said individual display state, said reception state detecting section detects that a reception state of one of said first tuner and said second tuner is equal to or lower than a predetermined threshold.

10. The receiving apparatus according to claim 1, further comprising:
a plurality of sound outputting sections corresponding to individual images with respect to said plurality of viewing directions;
a reception state detecting section detecting reception states of said plurality of tuners; and
a sound control section making said reception state detecting section detect a tuner whose reception state is equal to or lower than a predetermined threshold and controlling said sound outputting section so as to mute a sound corresponding to a broadcast program received through the detected tuner.

11. The receiving apparatus according to claim 1, further comprising:
a sound outputting section outputting a plurality of sounds corresponding to individual images with respect to said plurality of viewing directions;
an input source other than said plurality of tuners;
a reception state detecting section detecting reception states of said plurality of tuners; and
a sound control section making said reception state detecting section detect a tuner whose reception state is equal to or lower than a predetermined threshold and controlling said sound outputting section so as to switch a sound corresponding to a broadcast program, received by the detected tuner, to a sound from said input source.

12. The receiving apparatus according to claim 1, further comprising an antenna allocation specifying section specifying an allocation of said plurality of antennas to said plurality of tuners according to operating states of said tuners.

13. The receiving apparatus according to claim 1, further comprising:
a movement state detecting section detecting a movement state of a mobile object, on which said receiving apparatus is mounted; and
an antenna allocation specifying section specifying an allocation of said plurality of antennas to said plurality of tuners on the basis of a result of the detection by said movement state detecting section.
